(19) United States
(12) Patent Application Publication
(10) Pub. No.: US 2026/0016740 A1
(43) Pub. Date: Jan. 15, 2026

(54) PROJECTION DEVICE AND METHOD, PROJECTOR, DISPLAY SYSTEM, AND PICTURE ADJUSTMENT DEVICE

(71) Applicants: Beijing BOE Display Technology Co., Ltd., Beijing (CN); BOE Technology Group Co., Ltd., Beijing (CN); Beijing BOE Technology Development Co., Ltd., Beijing (CN)

(72) Inventors: Qirui TAN, Beijing (CN); Wei ZHANG, Beijing (CN); Xi LI, Beijing (CN); Jiaqiang WANG, Beijing (CN); Xiaolong LIU, Beijing (CN); Dalin DONG, Beijing (CN); Yujie WANG, Beijing (CN); Yu YANG, Beijing (CN)

(21) Appl. No.: 18/994,576

(22) PCT Filed: May 28, 2024
(86) PCT No.: PCT/CN2024/095767

§ 371 Date: Jan. 14, 2025

(30) Foreign Application Priority Data
May 29, 2023 (CN) 202310621214.X

(51) Int. Cl. G03B 21/14; G02F 1/29; G03B 21/00; G03B 21/16; G03B 21/20; G03B 21/28

(52) U.S. Cl. CPC G03B 21/142; G02F 1/29; G03B 21/006; G03B 21/16; G03B 21/2066; G03B 21/28; G03B 21/2033

(57) ABSTRACT

A projection device and method, a projector, a display system, and a picture adjustment device. The projection device comprises: a light source assembly; a display assembly arranged on the side of the light source assembly that emits light, the light emitted by the light source assembly being projected to the non-display side of the display assembly; and a liquid crystal lens arranged on the side of the display assembly away from the light source assembly, the focal length of the projection device being adjusted by the voltage applied to liquid crystal molecules in the liquid crystal lens.

### CROSS-REFERENCE TO RELATED APPLICATIONS

The present application is a U.S. National Phase Entry of International Application No. PCT/CN2024/095767 having an international filing date of May 28, 2024, which claims priority to Chinese patent application No. 202310621214. X, filed to the CNIPA on May 29, 2023, contents of the above-identified applications should be understood to be incorporated into the present application by reference.

### TECHNICAL FIELD

Embodiments of the present disclosure relate to, but are not limited to, the field of projection display technologies, and particularly relate to a projection device and method, a projector, a display system, and a picture adjustment device.

### BACKGROUND

A projector is an apparatus that may project an image or video onto a curtain or screen. Currently, there are three types of projectors: a Digital Light Processing (DLP) projector, a single Liquid Crystal Display (LCD) projector, and a 3 Liquid Crystal Display (LCD) projector. Three LCD screens are adopted for the 3LCD projector, a cost is a relatively high, and customers' willingness to use it is affected adversely. The single LCD projector is sought after by ordinary customers because only one LCD screen is adopted and a cost is relatively low.

### SUMMARY

The following is a summary of subject matters described herein in detail. This summary is not intended to limit the protection scope of claims.

In a first aspect, an embodiment of the present disclosure provides a projection device, including: a light source assembly; a display assembly disposed on a side of the light source assembly that emits light, wherein light emitted from the light source assembly is projected to a non-display side of the display assembly; and a liquid crystal lens disposed on a side of the display assembly away from the light source assembly, and a focal length of the projection device is adjusted through voltages applied to liquid crystal molecules in the liquid crystal lens.

In an exemplary implementation mode, the projection device further includes a lens assembly disposed on a display side of the display assembly, and a light incident side of the lens assembly is disposed close to the display side.

In an exemplary implementation mode, the lens assembly includes a plurality of liquid crystal sub-lenses, the liquid crystal lens and each of the liquid crystal sub-lenses each includes a first substrate and a second substrate disposed oppositely, and a liquid crystal layer disposed between the first substrate and the second substrate; a side of the first substrate close to the second substrate is provided with a first conductive layer, a side of the second substrate close to the first substrate is provided with a second conductive layer, the first conductive layer includes a plurality of first electrodes, and the second conductive layer includes a second electrode.

In an exemplary implementation mode, a first electrode has a ring-shaped structure, and the plurality of first electrodes are arranged at intervals along a direction from a center to an edge of the first substrate.

In an exemplary implementation mode, in the liquid crystal lens, the first substrate is located on a side of the liquid crystal lens close to the light source assembly, and the second substrate is located on a side of the liquid crystal lens away from the light source assembly.

In an exemplary implementation mode, the plurality of liquid crystal sub-lenses in the lens assembly include a first liquid crystal sub-lens, a second liquid crystal sub-lens, a third liquid crystal sub-lens, and a fourth liquid crystal sub-lens, and the first liquid crystal sub-lens to the fourth liquid crystal sub-lens are sequentially arranged along a direction from the light incident side to a light exit side.

In an exemplary implementation mode, in the first liquid crystal sub-lens and the fourth liquid crystal sub-lens, a first substrate is located on a side close to the second liquid crystal sub-lens, and a second substrate is located on a side away from the second liquid crystal sub-lens.

In the second liquid crystal sub-lens, a first substrate is located on a side close to the first liquid crystal sub-lens, and a second substrate is located on a side close to the third liquid crystal sub-lens.

In the third liquid crystal sub-lens, a first substrate is located on a side close to the fourth liquid crystal sub-lens, and a second substrate is located on a side close to the second liquid crystal sub-lens.

In an exemplary implementation mode, a refractive index of a liquid crystal molecule in the liquid crystal layer is:

$$n ( θ ) = \frac{{n}_{o} {n}_{e}}{\sqrt{{n}_{o}^{2} {sin}^{2} θ + {n}_{e}^{2} {cos}^{2} θ}} .$$

Herein, n(θ) is the refractive index of the liquid crystal molecule, θ is a deflection angle of the liquid crystal molecule, nₒ is a first refractive index, nₑ is a second refractive index, one of the first refractive index nₒ and the second refractive index nₑ is a maximum refractive index of the liquid crystal molecule, the other is a minimum refractive index of the liquid crystal molecule, and a value range of the refractive index n(θ) of the liquid crystal molecule is between the first refractive index nₒ and the second refractive index nₑ.

In an exemplary implementation mode, the projection device further includes a reflecting mirror.

The reflecting mirror is disposed on the light incident side of the lens assembly, light emitted from the display assembly is projected to a reflecting surface of the reflecting mirror via the liquid crystal lens, and light reflected by the reflecting surface is projected to the light incident side of the lens assembly.

In an exemplary implementation mode, each light emitting point corresponding to light projected to the display assembly in the light source assembly serves as a Lambert body.

In an exemplary implementation mode, the projection device further includes a focusing lens and a heat insulation structure, and the light source assembly includes a light source and a light reflecting structure.

The light reflecting structure is disposed on a side of the light source that emits light, the focusing lens is disposed on a side of the light reflecting structure far from the light source, the heat insulation structure is disposed between the focusing lens and the display assembly, and the heat insulation structure is disposed close to the focusing lens.

In an exemplary implementation mode, the focusing lens is a Fresnel lens, the display assembly is a liquid crystal display screen, the light source is a Light Emitting Diode (LED), and the heat insulation structure is heat insulation glass.

In a second aspect, an embodiment of the present disclosure also provides a projector including the projection device according to any one of the above embodiments.

In a third aspect, an embodiment of the present disclosure provides a display system, including: the projection device or projector according to any one of the above embodiments; and a projection curtain configured to project light emitted from the projection device or the projector to form a projection picture.

In a fourth aspect, an embodiment of the present disclosure also provides a projection picture adjustment device, which is applied to the projection device or the projector described in any of the above embodiments, the projection picture adjustment device includes a projection distance sensor and a processor, the projection device or the projector includes a liquid crystal lens, the liquid crystal lens includes a first conductive layer and a second conductive layer disposed oppositely, a liquid crystal layer is disposed between the first conductive layer and the second conductive layer, the first conductive layer includes a plurality of first electrodes, and the second conductive layer includes a second electrode.

The projection distance sensor is configured to sense a projection distance, to generate projection distance information according to the sensed projection distance, and to transmit the projection distance information to the processor.

The processor is configured to control voltages applied to the second electrode and the plurality of first electrodes according to the projection distance information.

In a fifth aspect, an embodiment of the present disclosure also provides a projection picture adjustment method, which is applied to the projection device or projector according to any one of the above embodiments. The projection device or projector includes a liquid crystal lens, the liquid crystal lens includes a first conductive layer and a second conductive layer disposed oppositely, a liquid crystal layer is disposed between the first conductive layer and the second conductive layer, the first conductive layer includes a plurality of first electrodes, and the second conductive layer includes a second electrode; and the method includes: sensing a projection distance and generating projection distance information according to the sensed projection distance; and controlling voltages applied to the second electrode and the plurality of first electrodes according to the projection distance information.

In a sixth aspect, an embodiment of the present disclosure also provides a projection method, which is applied to the projection device or projector according to any one of the above embodiments. The projection device or projector includes a liquid crystal lens, the liquid crystal lens includes a first conductive layer and a second conductive layer disposed oppositely, a liquid crystal layer is disposed between the first conductive layer and the second conductive layer, the first conductive layer includes a plurality of first electrodes, and the second conductive layer includes a second electrode; and the projection method includes: applying corresponding voltages to the second electrode and the plurality of first electrodes.

Other aspects of the present disclosure may be comprehended after drawings and detailed description are read and understood.

### BRIEF DESCRIPTION OF DRAWINGS

The accompanying drawings are intended to provide an understanding of technical solutions of the present application and form a part of the specification, and are used to explain the technical solutions of the present disclosure together with the embodiments of the present disclosure, and not intended to form limitations on the technical solutions of the present disclosure. Shapes and sizes of each component in the accompanying drawings do not reflect actual scales, but are only intended to schematically illustrate contents of the present disclosure.

FIG. 1 shows a schematic diagram of a structure of a projection device according to an embodiment of the present disclosure.

FIG. 2 shows a schematic diagram of a cross-sectional structure of a liquid crystal lens according to an exemplary embodiment of the present disclosure.

FIG. 3a shows a schematic diagram of a structure of a lens assembly according to an exemplary embodiment of the present disclosure.

FIG. 3b shows a schematic diagram of a lens assembly according to an exemplary embodiment of the present disclosure.

FIG. 4 shows a schematic diagram of an arrangement of first electrodes according to an exemplary embodiment of the present disclosure.

FIG. 5a shows a schematic diagram of a liquid crystal lens in a normal state according to an exemplary embodiment of the present disclosure.

FIG. 5b shows a schematic diagram of a liquid crystal lens in a state where a voltage is applied according to an exemplary embodiment of the present disclosure.

FIG. 6 shows a schematic diagram of a liquid crystal lens converging light according to an exemplary embodiment of the present disclosure.

FIG. 7 shows a schematic diagram of projecting of a projection device according to an exemplary embodiment of the present disclosure.

FIG. 8 shows a schematic diagram of a backward design optical path of a projection device according to an exemplary embodiment of the present disclosure.

FIG. 9 shows an enlarged schematic diagram of a backward design optical path of a projection device according to an exemplary embodiment of the present disclosure.

FIG. 10 shows a schematic diagram of a light spot morphology formed on a liquid crystal lens in a backward design process according to an exemplary embodiment of the present disclosure.

FIG. 11 shows a schematic diagram of a spot morphology formed on a display assembly in a backward design process according to an exemplary embodiment of the present disclosure.

FIG. 12 shows a schematic diagram of a projection system according to an embodiment of the present disclosure.

FIG. 13 shows a schematic diagram of a projection picture adjustment device according to an embodiment of the present disclosure.

FIG. 14 shows a flowchart of a projection picture adjustment method according to an embodiment of the present disclosure.

### DETAILED DESCRIPTION

The embodiments of the present disclosure will be described in detail hereinafter with reference to the drawings. It is to be noted that implementation modes may be implemented in multiple different forms. Those of ordinary skills in the art may easily understand such a fact that modes and contents may be transformed into various forms without departing from the purpose and scope of the present disclosure. Therefore, the present disclosure should not be explained as being limited to contents recorded in the following implementation modes only.

The embodiments and features in the embodiments of the present disclosure may be randomly combined with each other if there is no conflict. In order to keep following description of the embodiments of the present disclosure clear and concise, detailed description of part of known functions and known components are omitted in the present disclosure. The drawings of the embodiments of the present disclosure only involve structures involved in the embodiments of the present disclosure, and for other structures, reference may be made to conventional designs.

Scales of the drawings in the present disclosure may be used as a reference in actual processes, but are not limited thereto. For example, a width-length ratio of a channel, a thickness and spacing of each film layer, and a width and spacing of each signal line may be adjusted according to actual needs. A quantity of pixels in a display substrate and a quantity of sub-pixels in each pixel are not limited to numbers shown in the drawings. The drawings described in the present disclosure are schematic structural diagrams only, and one mode of the present disclosure is not limited to shapes, numerical values, or the like shown in the drawings.

Ordinal numerals “first”, “second”, “third”, etc., in the specification are set not to form limits in numbers but only to avoid confusion between constituent elements.

In the specification, for convenience, expressions “central”, “above”, “below”, “front”, “back”, “vertical”, “horizontal”, “top”, “bottom”, “inside”, “outside”, etc., for indicating directional or positional relationships are used to illustrate positional relationships between the constituent elements with reference to the accompanying drawings, not to indicate or imply that a referred apparatus or element must have a specific orientation or is structured and operated in the specific orientation but only to easily describe the present specification and simplify the description, and thus should not be understood as limitations on the present disclosure. The positional relationships between the constituent elements may be changed as appropriate based on a direction according to which each constituent element is described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, it may be a fixed connection, or a detachable connection, or an integral connection; it may be a mechanical connection or an electrical connection; it may be a direct connection, or an indirect connection through a middleware, or internal communication between two elements. A person skilled in the art may understand specific meanings of the above terms in the present disclosure according to actual situations.

In the specification, an “electrical connection” includes a case that constituent elements are connected together through an element with a certain electrical action. The “element with a certain electrical action” is not particularly limited as long as electrical signals between the connected constituent elements may be sent and received. Examples of the “element with a certain electrical action” not only include an electrode and a wiring, but also include a switching element such as a transistor, a resistor, an inductor, a capacitor, another element with various functions, etc.

In the specification, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

In the specification, a “film” and a “layer” are interchangeable. For example, a “conductive layer” may be replaced with a “conductive film” sometimes. Similarly, an “insulation film” may be replaced with an “insulation layer” sometimes.

A triangle, rectangle, trapezoid, pentagon, or hexagon, etc. in the specification is not strictly defined, and it may be an approximate triangle, rectangle, trapezoid, pentagon, or hexagon, etc. There may be some small deformations caused by tolerance, and there may be a chamfer, an arc edge, deformation, etc.

In the present disclosure, “about” means that a boundary is not defined so strictly and numerical values within process and measurement error ranges are allowed.

A single LCD projector mainly includes a light source, and a light reflecting cup, a first Fresnel lens, a heat insulation glass, an LCD display screen, a second Fresnel lens, a reflecting mirror, and an imaging lens which are sequentially disposed along a propagation direction of an emitted light of the light source. The imaging lens is usually a lens group, and the lens group includes a plurality of lenses. There are two main zoom methods of a single LCD projector with zoom. One method is to manually rotate a lens group when a projection distance changes, so that a working distance between the lens group and an LCD display screen changes, and a second Fresnel lens remains unmoved, resulting in a change in focal length. This zoom method requires manual adjustment for each zoom, and is suitable for a place with a fixed projection distance, such as a meeting room where a fixed projector is hung. The other method is that a distance sensor senses a distance when a projection distance changes, a lens group is rotated through a motor, so that a working distance between the lens group and an LCD display screen changes, and a second Fresnel lens remains unmoved, resulting in a change in a focal length. This method is automatically adjusted every time and is suitable for a place where a projector distance changes, such as a home with a non-fixed projector.

At present, a single LCD projector has following problems after zooming. Firstly, since a lens group of the single LCD projector moves in a zooming process, imaging quality will decrease after zooming. In a design process of an imaging lens, image quality will be optimized under a condition of projecting pictures with sizes of 40 inches, 60 inches, 80 inches, 100 inches, and 120 inches (which may be understood as: for multiple sizes of projection pictures, it is necessary to optimize image quality of each size of projection picture separately), but it cannot meet a requirement of better image quality under each picture size at the same time. Therefore, 80 inches is generally selected to obtain better image quality (i.e., picture quality of a projection), when the projection picture changes, a face type of a processed imaging lens is fixed, and the image quality under non-80 inches pictures will decrease. Secondly, whether it is manual focusing or automatic focusing, there will be a certain installation tolerance in a rotation mechanism of the imaging lens in a focusing process. A movement trajectory of the imaging lens does not move strictly according to an axis, and deviation with a slight angle will also lead to decrease of imaging quality. Thirdly, in the focusing process, there is friction in the rotation mechanism of the imaging lens, and after a long time, there will be a problem of off-axis of the imaging lens, which will also lead to decrease of the imaging quality. Fourthly, a processing process of the second Fresnel lens is limited by technology and cost, and an edge morphology of a lens is quite different from that of an ideal model, which affects imaging quality of a field of view of an edge of the projection picture adversely. Fifthly, a mechanical structure of automatic focusing will produce noise during operation, and a motor and a steering structure will also increase additional cost of the projector Sixthly, for some projectors with a large-size single LCD, such as a single LCD projector with 5 inches (a size of a display assembly 14, not a size of a projection picture) and a resolution of 2K or 4K, in a design process of an imaging lens, considering optimization of imaging quality, a working distance from a lens to an LCD is very short. Moving the lens in a zoom process will cause the lens to block an optical path and also affect the image quality adversely. It may be seen that an existing single LCD projector has problems of a high preparation cost and degradation of picture quality of a projection after zooming.

An embodiment of the present disclosure provides a projection device, which may include: a light source assembly; a display assembly disposed on a side of the light source assembly that emits light, wherein light emitted from the light source assembly is projected to a non-display side of the display assembly; and a liquid crystal lens disposed on a side of the display assembly away from the light source assembly, wherein a focal length of the projection device is adjusted through voltages applied to liquid crystal molecules in the liquid crystal lens.

In a projection device according to an embodiment of the present disclosure, a focal length of the projection device is adjusted through voltages applied to liquid crystal molecules in a liquid crystal lens, and a problem of degradation of picture quality of a projection after zooming may be avoided.

As shown in FIG. 1, a projection device according to an embodiment of the present disclosure may include: a light source assembly 11; a display assembly 14 disposed on a side of the light source assembly 11 that emits light, wherein light emitted from the light source assembly 11 is projected to a non-display side of the display assembly 14; and a liquid crystal lens 15 disposed on a side of the display assembly 14 away from the light source assembly 11, wherein a focal length of the projection device is adjusted through voltages applied to liquid crystal molecules in the liquid crystal lens 15.

In an exemplary implementation mode, as shown in FIG. 1, the projection device may further include a lens assembly 17, the lens assembly 17 is disposed on a display side M12 of the display assembly 14, and a light incident side M21 of the lens assembly 17 is disposed close to the display side M12.

In an embodiment of the present disclosure, as shown in FIG. 1, the display assembly 14 may include a non-display side M11 and a display side M12. The non-display side M11 is located on a side of the display assembly 14 close to the light source assembly 11, and the display side M12 is located on a side of the display assembly 14 away from the light source assembly 11. The lens assembly 17 may include a light incident side M21 and a light exit side M22, the lens assembly 17 is disposed on a side of the display assembly 14 away from the light source assembly 11, and the light incident side M21 of the lens assembly 17 is located close to the display side M12 of the display assembly 14.

In an exemplary implementation mode, as shown in FIGS. 1 to 3a, the lens assembly 17 may include a plurality of liquid crystal sub-lenses. The liquid crystal lens 15 and each of the liquid crystal sub-lenses may each include a first substrate 151 and a second substrate 152 disposed oppositely, and a liquid crystal layer 155 disposed between the first substrate 151 and the second substrate 152. A side of the first substrate 151 close to the second substrate 152 is provided with a first conductive layer 153, a side of the second substrate 152 close to the first substrate 151 is provided with a second conductive layer 154, the first conductive layer 153 includes a plurality of first electrodes 1531, and the second conductive layer 154 includes a second electrode 1541.

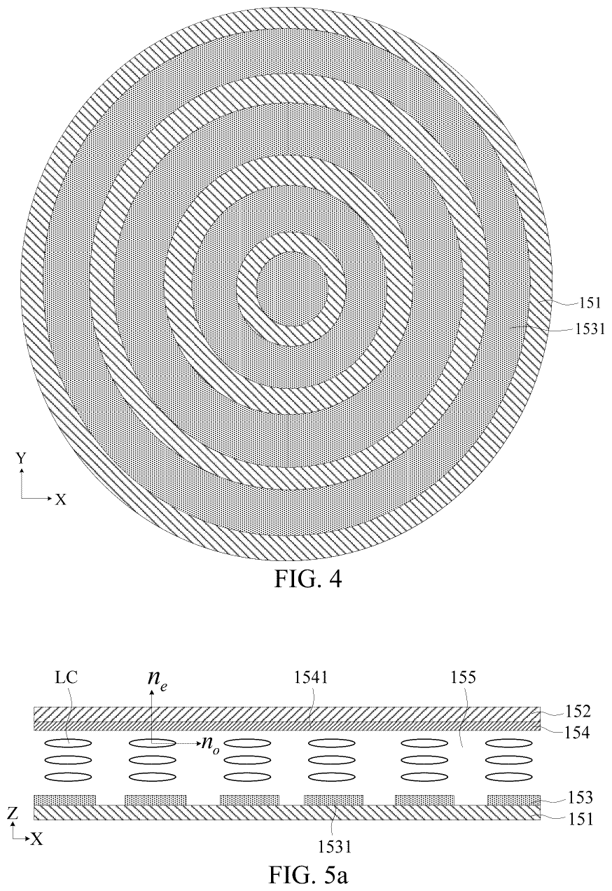

In an exemplary implementation mode, as shown in FIG. 4, a first electrode 1531 may be of a ring-shaped structure, and the plurality of first electrodes 1531 may be arranged at intervals along a direction from a center to an edge of the first substrate 151. As shown in FIG. 4, the first electrode 1531 may, but is not limited to, be of a circular ring-shaped structure, for example, the first electrode 1531 may be of an elliptical ring-shaped structure. Accordingly, the first substrate 151, the second substrate 152, and the second conductive layer 154 may be of a circular structure or an elliptical structure. In an exemplary implementation mode, radii of ring-shaped structures of the plurality of first electrodes 1531 sequentially increase along the direction from the center to the edge of the first substrate 151. In an exemplary implementation mode, the first electrode 1531 located at a central position of the first substrate 151 (that is, a first electrode 1531 having a smallest radius) may be of a circular or elliptical structure (as shown in FIG. 4), or may be of a circular ring-shaped structure or an elliptical ring-shaped structure.

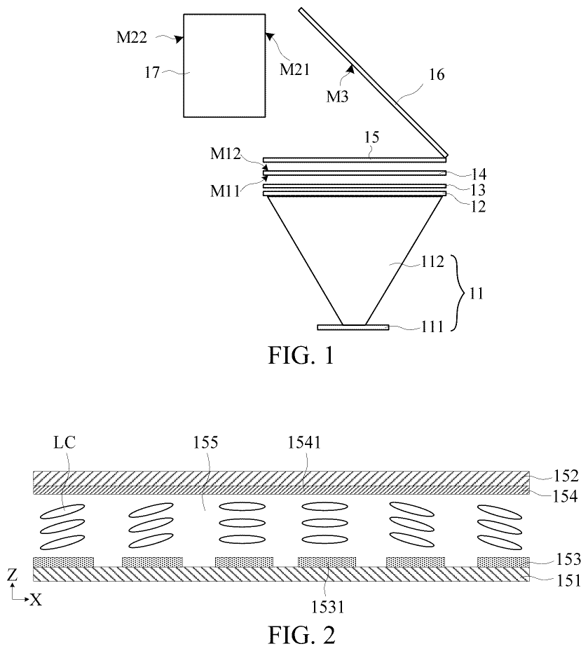

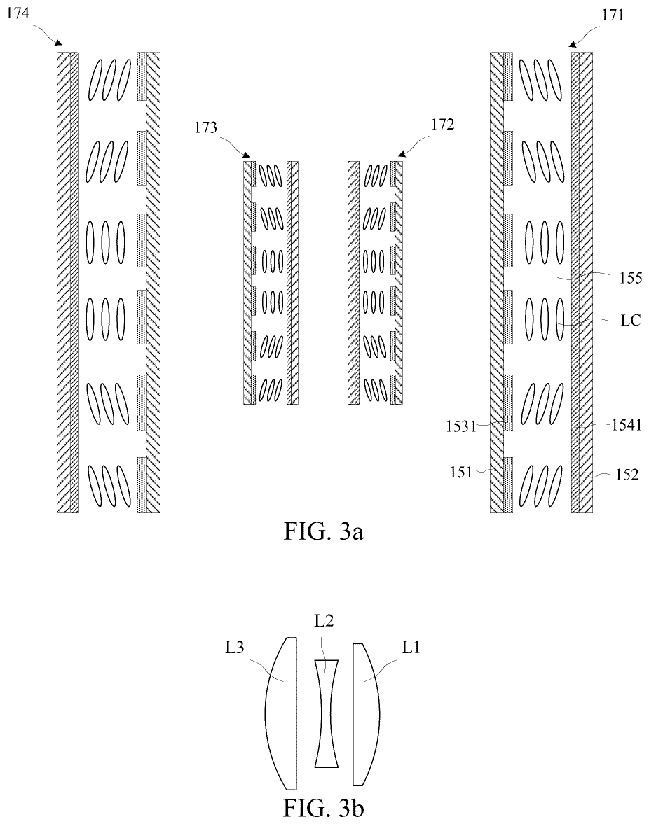

In an exemplary implementation mode, as shown in FIGS. 2 and 3a, there is an overlapped region between orthographic projections of the plurality of first electrodes 1531 on the first substrate 151 and an orthographic projection of the second electrode 1541 on the first substrate 151. For example, the orthographic projections of the plurality of first electrodes 1531 on the first substrate 151 are located within a range of the orthographic projection of the second electrode 1541 on the first substrate 151. In an embodiment of the present disclosure, the second electrode 1541 may be a common electrode, and a shape of the common electrode may be consistent with shapes of the first substrate 151 and the second substrate 152, for example, a shape of the second electrode 1541 (the common electrode) may be a circular structure or an elliptical structure. In an embodiment of the present disclosure, a size of the second electrode 1541 may be consistent with that of the first substrate 151 and the second substrate 152, or the size of the second electrode 1541 may be less than that of the first substrate 151 and the second substrate 152. In an exemplary implementation mode, an orthographic projection of the second electrode 1541 on the second substrate 152 may be located within a range of the second substrate 152.

In an exemplary implementation mode, as shown in FIG. 2, in the liquid crystal lens 15, the first substrate 151 may be located on a side of the liquid crystal lens 15 close to the light source assembly 11, and the second substrate 152 may be located on a side of the liquid crystal lens 15 away from the light source assembly 11.

In an embodiment of the present disclosure, by applying corresponding voltages to the plurality of first electrodes 1531 and the second electrode 154 in the liquid crystal lens 15, a plurality of liquid crystal molecules LC corresponding to the plurality of first electrodes 1531 may be deflected, thereby changing refractive indexes of corresponding positions, and thus a focal length of the liquid crystal lens 15 is changed. Therefore, static focusing of the projection device may be achieved through controlling voltages on the plurality of first electrodes and second electrode in the liquid crystal lens 15.

In an exemplary implementation mode, as shown in FIGS. 1 and 3a, the plurality of liquid crystal sub-lenses in the lens assembly 17 may include a first liquid crystal sub-lens 171, a second liquid crystal sub-lens 172, a third liquid crystal sub-lens 173, and a fourth liquid crystal sub-lens 174, and the first liquid crystal sub-lens 171 to the fourth liquid crystal sub-lens 174 are sequentially arranged along a direction from the light incident side M21 to the light exit side M22 of the lens assembly 17.

In an exemplary implementation mode, as shown in FIG. 3a, in the first liquid crystal sub-lens 171 and the fourth liquid crystal sub-lens 174, the first substrate 151 is located on a side close to the second liquid crystal sub-lens 172, and the second substrate 152 is located on a side away from the second liquid crystal sub-lens 172.

In the second liquid crystal sub-lens 172, the first substrate 151 is located on a side close to the first liquid crystal sub-lens 171, and the second substrate 152 is located on a side close to the third liquid crystal sub-lens 173.

In the third liquid crystal sub-lens 173, the first substrate 151 is located on a side close to the fourth liquid crystal sub-lens 174, and the second substrate 152 is located on a side close to the second liquid crystal sub-lens 172.

In an embodiment of the present disclosure, after applying voltages to a first electrode and a second electrode in the second liquid crystal sub-lens 172 and the third liquid crystal sub-lens 173, which may be combined to be equivalent to one concave lens, and after applying voltages to a first electrode and a second electrode in the first liquid crystal sub-lens 171 and the fourth liquid crystal sub-lens 174, which may be equivalent to two convex lenses, that is, the first liquid crystal sub-lens 171 may be equivalent to a convex lens after a voltage is applied. The fourth liquid crystal sub-lens 174 may be equivalent to a convex lens after a voltage is applied, and the second liquid crystal sub-lens 172 and the third liquid crystal sub-lens 173 may be combined to be equivalent to one concave lens after voltages are applied. Among them, focal lengths of a concave lens and a convex lens formed by a liquid crystal sub-lens may be controlled through voltages applied to a first electrode and a second electrode.

In an exemplary implementation mode, as shown in FIG. 3b, the lens assembly 17 may further include a first lens L1, a second lens L2, and a third lens L3 which are arranged sequentially along a direction from the light incident side M21 to the light exit side M22. In an exemplary implementation mode, the three lenses shown in FIG. 3b is a schematic diagram of an equivalent structure, and each lens structure may include a plurality of lenses. In an embodiment of the present disclosure, the second liquid crystal sub-lens 172 and the third liquid crystal sub-lens 173 in FIG. 3a may be equivalent to the second lens L2, the first liquid crystal sub-lens 171 may be equivalent to the first liquid crystal lens L1, and the fourth liquid crystal sub-lens 174 may be equivalent to the third liquid crystal lens L3. In an embodiment of the present disclosure, a quantity of liquid crystal sub-lenses in the lens assembly 17 may not be limited to four, but may be more than four, and an equivalent structure of the lens assembly 17 formed by more than four liquid crystal sub-lenses may be the same as the equivalent structure of FIG. 3b.

In an exemplary implementation mode, a refractive index of a liquid crystal molecule LC in the liquid crystal layer 155 may be:

$$n ( θ ) = \frac{{n}_{o} {n}_{e}}{\sqrt{{n}_{o}^{2} {sin}^{2} θ + {n}_{e}^{2} {cos}^{2} θ}} .$$

Herein, n(θ) is the refractive index of the liquid crystal molecule LC, θ is a deflection angle of the liquid crystal molecule LC, nₒ is a first refractive index, nₑ is a second refractive index, one of the first refractive index nₒ and the second refractive index nₑ is a maximum refractive index of the liquid crystal molecule LC, the other is a minimum refractive index of the liquid crystal molecule LC, and a value range of the refractive index n(θ) of the liquid crystal molecule LC is between the first refractive index nₒ and the second refractive index nₑ.

In an exemplary implementation mode, the first refractive index nₒ may be a refractive index of the liquid crystal molecule LC in a case that an electric field is applied to the corresponding liquid crystal molecule LC through a first electrode 1531 and a second electrode 1541, the second refractive index nₑ may be a refractive index of the liquid crystal molecule LC in a case that an electric field is not applied to the corresponding liquid crystal molecule LC through the first electrode 1531 and the second electrode 1541. In an exemplary implementation mode, the first refractive index nₒ may be the maximum refractive index of the liquid crystal molecule LC, and the second refractive index nₑ may be the minimum refractive index of the liquid crystal molecule LC.

In an exemplary implementation mode, as shown in FIG. 1, the projection device may further include a reflecting mirror 16.

The reflecting mirror 16 is disposed on the light incident side M21 of the lens assembly 17, and light emitted from the display assembly 14 is projected onto a reflecting surface M3 of the reflecting mirror 16 via the liquid crystal lens 15, and light reflected by the reflecting surface M3 is projected onto the light incident side M21 of the lens assembly 17.

In an embodiment of the present disclosure, the reflecting mirror 16 may enable an optical path to be lengthened in a case that a volume of the projection device remains unchanged, thereby saving space of the projection device, and reducing the volume of the projection device.

In an exemplary implementation mode, each light emitting point corresponding to light projected to the display assembly 14 in the light source assembly 11 may serve as a Lambert body. Light within a range of ±100 of a center of the Lambert body is used to achieve uniformity of brightness at a center position and an edge position of the display assembly 14, thereby improving uniformity of brightness at a center position and an edge position of a projection picture.

In an exemplary implementation mode, as shown in FIG. 1, the projection device may further include a focusing lens 12 and a heat insulation structure 13, and the light source assembly 11 includes a light source 111 and a light reflecting structure 112; the light reflecting structure 112 is disposed on a side of the light source 111 that emits light, the focusing lens 12 is disposed on a side of the light reflecting structure 112 away from the light source 111, the heat insulation structure 13 is disposed between the focusing lens 12 and the display assembly 14, and the heat insulation structure 13 is disposed close to the focusing lens 12.

In an embodiment of the present disclosure, the light reflecting structure 112 may be a light reflecting cup, and light emitted from the light source 111 enters from a light inlet of the light reflecting cup, and the light is reflected by an inner wall of the light reflecting cup, and is emitted from a light outlet of the light reflecting cup. The focusing lens 12 may be a Fresnel lens and is disposed on a side of the light outlet of the light reflecting cup. After light emitted from the light source 111 is reflected by the light reflecting cup, it is focused by the Fresnel lens (i.e., focusing lens 12) to form approximately collimated light (i.e., approximately parallel light). The approximately collimated light is projected to the non-display side M11 of the display assembly 14 through the heat insulation structure 13, and a picture displayed on the display side M12 of the display assembly 14 is converged through the liquid crystal lens 15 and then projected through the lens assembly 17 to form a projection picture on a projection curtain. In an embodiment of the present disclosure, in a case that the projection device is provided with the reflecting mirror 16, a picture displayed on the display side M12 of the display assembly 14 is converged through the liquid crystal lens 15 and then projected through the reflecting mirror 16 and the lens assembly 17 to form a projection picture on a projection curtain.

In an exemplary implementation mode, the display assembly 14 may be a liquid crystal display screen or another transparent display screen, for example, may be a transparent Organic Light Emitting Diode (OLED) display screen. The light source 111 may be a Light Emitting Diode (LED) light source. The heat insulation structure 13 may be heat insulation glass, and the heat insulation structure 13 may filter out at least part of unnecessary light during display of the display assembly 14 to prevent the display assembly 14 from absorbing too much useless heat. For example, the heat insulation glass may filter out light invisible to human eyes, may filter out infrared light and ultraviolet light, and light such as infrared light and ultraviolet light will not be projected to the display assembly 14, so as to prevent the display assembly 14 from absorbing too much heat and generating heat, and thus display performance degradation caused by heating may be avoided.

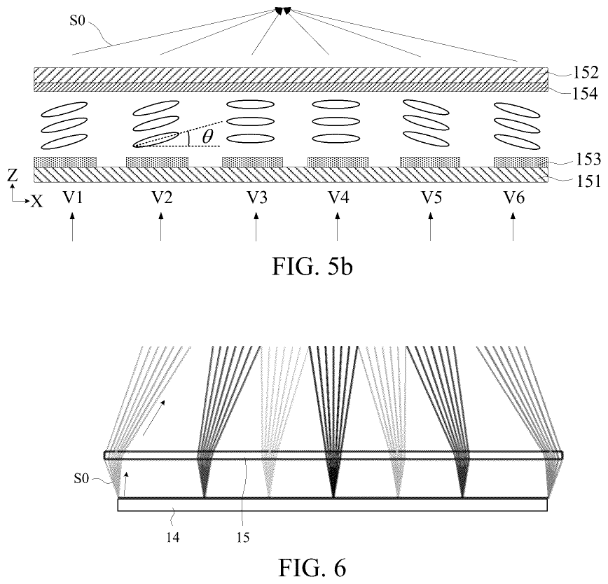

In an exemplary implementation mode, the first substrate 151 and the second substrate 152 may be transparent substrates, for example, may be transparent glass substrates, and after the first substrate 151 and the second substrate 152 are disposed oppositely, the liquid crystal layer 155 is filled between the first substrate 151 and the second substrate 152 to form a liquid crystal cell. The first electrode 1531 and the second electrode 1541 may be of an Indium Tin Oxide (ITO) conductive structure, and for example, the above-described first electrode 1531 and the second electrode 1541 may be formed by plating a nano Indium Tin metal Oxide electrode (ITO) on a side of the first substrate 151 and the second substrate 152 close to the liquid crystal layer 155. An alignment processing may be performed on the side of the first electrode 1531 and the second electrode 1541 close to the liquid crystal layer 155 to provide an initial position and angle for a liquid crystal molecule. When the liquid crystal lens 15 is in a state that no voltage is applied, liquid crystal molecules LC are in a parallel state with the glass substrate, and as shown in FIG. 5a, orientation of the liquid crystal molecules follows an alignment direction on the glass substrate. When a drive voltage is applied to the first electrode 1531 and the second electrode 1541, a corresponding electric field is generated in the liquid crystal cell, and the electric field in the liquid crystal cell drives a dipole moment of a forward liquid crystal molecule, so that the orientation of the liquid crystal molecule begins to turn to a direction of the electric field, and a magnitude of a degree of this turning is determined by a magnitude of the electric field in which the liquid crystal molecule is located, and an electric field intensity at a corresponding position in the liquid crystal cell may be changed (i.e., controlling a magnitude of the voltage applied to the first electrode 1531 and the second electrode 1541) to control turning of the liquid crystal molecule.

In an embodiment of the present disclosure, the liquid crystal lens 15 may serve as a liquid crystal light modulator, and deflection angles of liquid crystal molecules LC at different positions are controlled by adjusting voltages applied to the first electrode 1531 and the second electrode 1541, thereby changing the focal length of the liquid crystal lens 15.

In an exemplary implementation mode, as shown in FIG. 5a, in a normal state, molecules inside the liquid crystal lens 15 are arranged in a natural order, and the molecules have an extraordinary light refractive index nₑ (i.e., the second refractive index nₑ) and an ordinary light refractive index nₒ (i.e., the first refractive index nₒ). A liquid crystal molecule LC exhibits the extraordinary light refractive index nₑ (the second refractive index nₑ) in a case that an electric field is not applied (no voltage is applied to the first electrode 1531 and second electrode 1541); in a case that an electric field is applied (a voltage is applied to the first electrode 1531 and the second electrode 1541), the liquid crystal molecule LC will generate rotation toward a certain direction, as shown in FIG. 5b, a refractive index of the liquid crystal molecule becomes

$$n ( θ ) = \frac{{n}_{o} {n}_{e}}{\sqrt{{n}_{o}^{2} {sin}^{2} θ + {n}_{e}^{2} {cos}^{2} θ}} .$$

In an exemplary implementation mode, the liquid crystal molecules LC have a birefringence characteristic, and a birefringence formula thereof may be:

$$\frac{{sin}^{2} θ}{{n}_{e}^{2}} + \frac{{cos}^{2} θ}{{n}_{o}^{2}} = \frac{1}{{n ( θ )}^{2}} .$$

According to the birefringence formula, it may be deduced that when orientation (i.e., a deflection direction of a liquid crystal molecule) of the liquid crystal molecule LC in the liquid crystal lens 15 forms a θ angle with orientation of a liquid crystal in a state that no voltage is applied to the first electrode and the second electrode, a refractive index in a vertical direction (Z direction) may be:

$$n ( θ ) = \frac{{n}_{o} {n}_{e}}{\sqrt{{n}_{o}^{2} {sin}^{2} θ + {n}_{e}^{2} {cos}^{2} θ}} .$$

The refractive index n(θ) of the liquid crystal molecule LC changes between nₑ and nₒ a with change of a deflection angle θ of the liquid crystal molecule. Since an orientation angle θ of the liquid crystal molecule may be controlled by an external electric field (an electric field applied to the first electrode 1531 and the second electrode 1541), the refractive index n(θ) of the liquid crystal molecule LC may be controlled by the external electric field. As shown in FIG. 5b, after a first voltage V1 to a sixth voltage V6 are sequentially applied to a plurality of first electrodes (for example, among six adjacent first electrodes 1531, in an arrangement direction of the six first electrodes 1531, a first voltage V1 is applied to a first first electrode, a second voltage V2 is applied to a second first electrode, a third voltage V3 is applied to a third first electrode, a fourth voltage V4 is applied to a fourth first electrode, a fifth voltage V5 is applied to a fifth first electrode, and a sixth voltage V6 is applied to a sixth first electrode), a convergence effect as shown in FIG. 5b may be achieved after light S0 passes through the liquid crystal lens 15. In order to make brightness of a center and an edge of a projection picture consistent, each light emitting point of the center and the edge of the display assembly 14 may be considered as a Lambert body, and consistency of the brightness of the center and the edge of the display assembly 14 is achieved by using light within a range of ±10° of centers of these Lambert bodies, so that brightness of a center and an edge of the projection picture on a projection screen is basically consistent. As shown in FIG. 6, it is an effect diagram after light is converged by the center and the edge of the liquid crystal lens 15. By applying different voltages to the first electrodes 1531 at different positions on the liquid crystal lens 15, deflection angles of liquid crystal molecules at different positions are different, and thus, it is achieved that the liquid crystal lens 15 achieves an effect of concentrating (focusing) light.

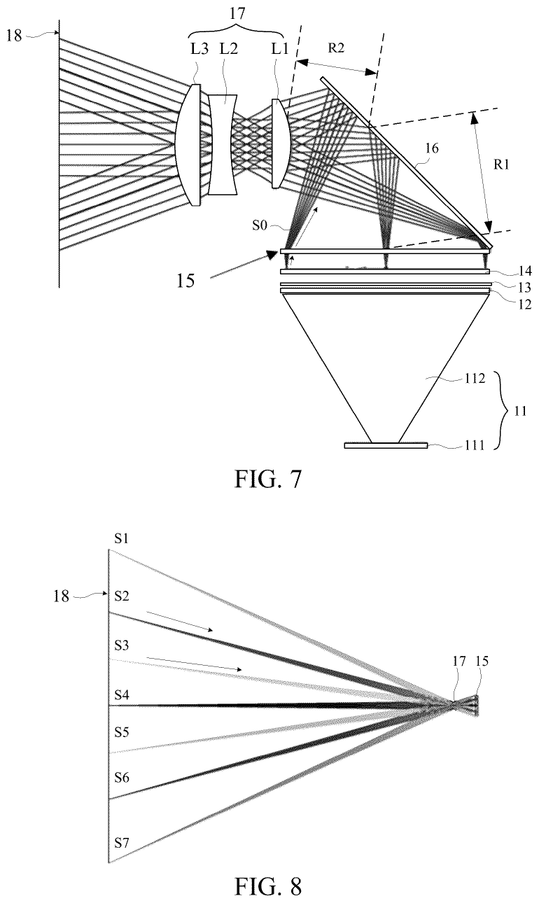

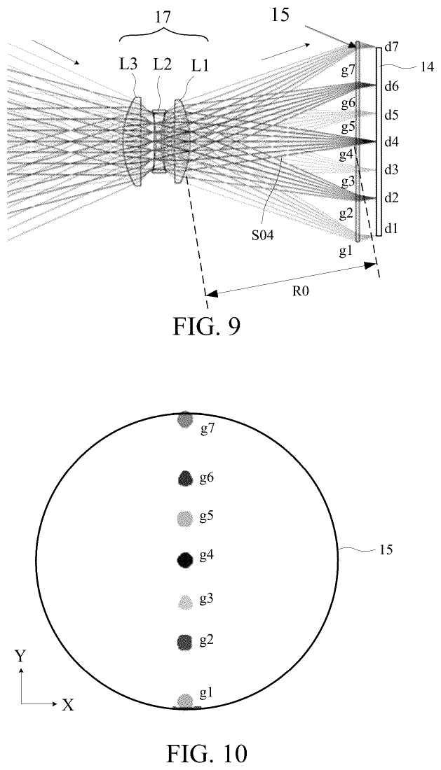

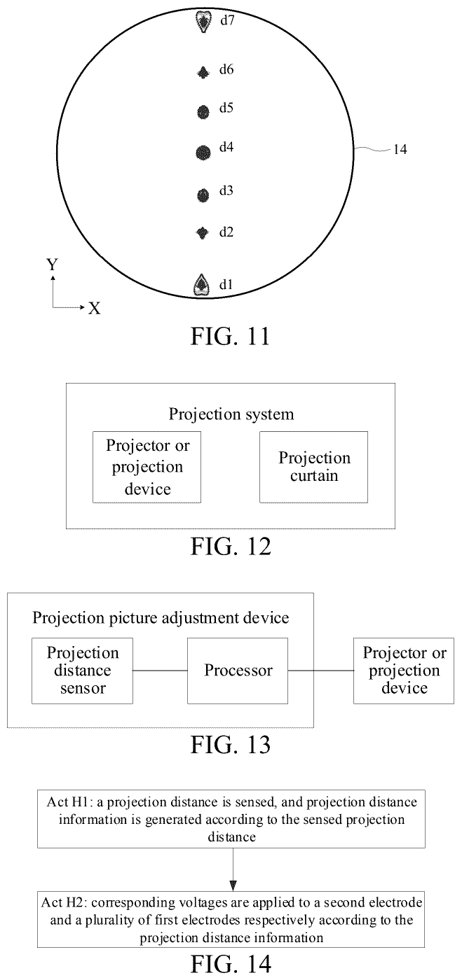

In an exemplary implementation mode, as shown in FIG. 7, in a projection process, a process of projecting a picture of the display assembly 14 in a projector onto a curtain is a forward optical path, that is, a picture generated by the display assembly 14 is converged by the liquid crystal lens 15, then, through the reflecting mirror 16 and the lens assembly 17 (a lens with a plurality of lenses may be adopted or a plurality of liquid crystal sub-lenses as shown in FIG. 3a may be adopted for the lens assembly 17), and then it is projected onto the curtain 18. However, in a design process of an optical path, a design method of a backward optical path is usually adopted. FIG. 8 shows an overall optical path diagram of a backward design, FIG. 9 shows a partial enlarged optical path diagram of the backward design. Light emitted by a point light source on a projection curtain 18 passes through the lens assembly 17 and converges on the liquid crystal lens 15 to form a light spot. FIG. 10 shows a schematic diagram of a morphology of the light spot on the liquid crystal lens 15, and then it is converged on the display assembly 14 through the liquid crystal lens 15 to form a spot. As shown in FIG. 11, it is a schematic diagram of the spot formed on the display assembly 14. In order to achieve better imaging quality, a diameter of the spot on the display assembly 14 is less than a size of a pixel of the display assembly 14.

In an exemplary implementation mode, under a condition that an optical path distance is unchanged, a structure in which the reflecting mirror 16 is disposed as shown in FIG. 7 may save space compared with a structure in which no reflecting mirror is disposed as shown in FIG. 8. For example, an optical path distance of one beam of light S04 from the liquid crystal lens 15 to the lens assembly in FIG. 8 is R0, which is consistent with a sum of a first optical path distance R1 and a second optical path distance R2 in FIG. 7, that is, a relationship between R0, R1, and R2 may be: R0=R1+R2.

In an exemplary implementation mode, in a design process of a backward optical path, as shown in FIG. 8, seven light sources S1 to S7 on the projection curtain 18 sequentially correspond to seven field angles of view in the lens assembly 17, and light spots where light emitted by the seven light sources S1 to S7 converge on the liquid crystal lens 15 sequentially correspond to g1 to g7 in FIG. 9 (which may be understood as, S1 corresponds to g1, S2 corresponds to g2, and so on, S7 corresponds to g7). Spots formed on the display assembly 14 correspond to d1 to d7 in FIG. 9, that is, a light spot formed on the liquid crystal lens 15 by the light source S1 is g1, and a spot formed on the display assembly 14 is d1; a light spot formed on the liquid crystal lens 15 by the light source S2 is g2, and a spot formed on the display assembly 14 is d2; a light spot formed on the liquid crystal lens 15 by a light source S3 is g3, and a spot formed on the display assembly 14 is d3; and so on, a light spot formed on the liquid crystal lens 15 by the light source S7 is g7, and a spot formed on the display assembly 14 is d7. Light spots formed on the liquid crystal lens 15 are shown in FIG. 10, and spots formed on the display assembly 14 are shown in FIG. 11.

As shown in FIGS. 10 and 11, in a plane in which a first direction X and a second direction Y are located, in the second direction Y, a first spot d1 to a seventh spot d7 are sequentially arranged along the second direction Y, and a first light spot g1 to a seventh light spot g7 are sequentially arranged along the second direction Y. In structures shown in FIGS. 10 and 11, the liquid crystal lens 15 and the display assembly 14 are disposed to have a circular structure, diameters of the liquid crystal lens 15 and the display assembly 14 may be several tens of millimeters to several hundred millimeters, and an actual size may be set according to an actual projection device. Values of field angles of view corresponding to the first spot d1 to the seventh spot d7 and Root Mean Square (RMS) radii of the first spot d1 to the seventh spot d7 in FIG. 11 are shown in Table 1.

TABLE 1

| Spot position | d1 | d2 | d3 | d4 | d5 | d6 | d7 |
|---|---|---|---|---|---|---|---|
| Field angle of view | −50 | −30 | −15 | 0 | 15 | 30 | 50 |
| (degree) | | | | | | | |
| Value of Root Mean | 45.442 | 37.440 | 30.832 | 37.767 | 30.832 | 37.440 | 45.442 |
| Square radius | | | | | | | |
| (micron) | | | | | | | |

As shown in Table 1, field angles of view of the first spot d1 to the seventh spot d7 in FIG. 11 are sequentially −50°, −30°, −15°, 0°, 15°, 30°, and 50°, and the values of Root Mean Square RMS (RMS) radii (root mean square radii) of the first spot d1 to the seventh spot d7 are sequentially 45.442 microns, 37.440 microns, 30.832 microns, 37.767 microns, 30.832 microns, 37.440 microns, and 45.442 microns. In an exemplary implementation mode, the values of the Root Mean Square RMS (RMS) radii of the first spot d1 to the seventh spot d7 are between 30 microns and 46 microns, and a size is less than a size of one pixel in the display assembly 14. In an exemplary implementation mode, as shown in FIG. 11, in a plane where the display assembly 14 is located, the first spot d1 and the seventh spot d7 may be symmetrical with respect to the fourth spot d4, the second spot d2 and the sixth spot d6 may be symmetrical with respect to the fourth spot d4, and the third spot d3 and the fifth spot d5 may be symmetrical with respect to the fourth spot d4. That is, morphologies of the first spot d1 and seventh spot d7 may be symmetrical with respect to the fourth spot d4, morphologies of the second spot d2 and the sixth spot d6 may be symmetrical with respect to the fourth spot d4, and morphologies of the third spot d3 and the fifth spot d5 may be symmetrical with respect to the fourth spot d4.

In an exemplary implementation mode, the first spot d1 to the seventh spot d7 in FIG. 11 sequentially correspond to the first light spot g1 to the seventh light spot g7 in FIG. 10, and field angles of view of the first spot d1 to the seventh spot d7 are sequentially consistent with the field angles of view of the first light spot g1 to the seventh light spot g7, that is, the field angles of view of the first light spot g1 to the seventh light spot g7 are sequentially −50°, −30°, −15°, 0°, 15°, 30°, and 50°. In an exemplary implementation mode, as shown in FIG. 10, the first light spot g1 and the seventh light spot g7 may be symmetrical with respect to the fourth light spot g4, the second light spot g2 and the sixth light spot g6 may be symmetrical with respect to the fourth light spot g4, and the third light spot g3 and the fifth light spot g5 may be symmetrical with respect to the fourth light spot g4. That is, morphologies of the first light spot g1 and seventh light spot g7 may be symmetrical with respect to the fourth light spot g4, morphologies of the second light spot g2 and the sixth light spot g6 may be symmetrical with respect to the fourth light spot g4, and morphologies of the third light spot g3 and the fifth light spot g5 may be symmetrical with respect to the fourth light spot g4.

In an embodiment of the present disclosure, in a design process of the lens assembly 17, image quality will be optimized respectively in cases of projecting pictures of 40 inches, 60 inches, 80 inches, 100 inches, and 120 inches (it may be understood that: for multiple sizes of projection pictures, image quality needs to be optimized separately for each size of projection picture), but it cannot meet a requirement of better image quality under each picture at the same time. Therefore, 80 inches is generally selected to obtain better image quality. When a projection picture changes, a face type of the lens assembly 17 formed by a plurality of lenses is fixed, and image quality under a non-80 inches picture will decrease, and thus voltages of electrodes at different positions (first electrodes 1531 at different positions) of the liquid crystal lens 15 may be adjusted so that deflection angles of liquid crystal molecules at different positions are different, and light spots on the liquid crystal lens 15 are re-converged to a surface of an LCD to form a spot, a diameter of the spot is less than a size of one pixel of the LCD, as shown in FIG. 11. In this way, better image quality may be obtained in cases that pictures of 40 inches, 60 inches, 80 inches, 100 inches, and 120 inches are projected. In an embodiment of the present disclosure, by controlling voltages of a plurality of first electrodes 1531 in the liquid crystal lens 15, optimization of imaging quality under different projection distances and projection pictures with different sizes may be achieved, so that better image quality can be achieved under different projection distances and projection pictures with different sizes. In an embodiment of the present disclosure, a projection picture of each size, a corresponding projection distance, and a voltage of better image quality applied to the second electrode and the plurality of first electrodes may be saved, and a corresponding voltage may be applied to the first electrodes and the second electrode according to a size of a projection picture and a projection distance in a projection process, so that it is achieved that better image quality may be achieved for each projection picture size and projection distance.

In an embodiment of the present disclosure, static focusing may be achieved using the liquid crystal lens 15 instead of a Fresnel lens, and the lens assembly 17 does not need to be adjusted in a focusing process, and there is no installation tolerance of the lens assembly 17 after focusing, and degradation of imaging quality of a projection due to zoom may be avoided. In the focusing process, by controlling a power supply of an electrode of the liquid crystal lens, mechanical focusing is not required, a position of a component in the lens assembly 17 is not adjusted, and there is no off-axis problem of the lens assembly 17, so that degradation of imaging quality may be avoided. A morphology of a lens edge of the liquid crystal lens will not affect imaging quality of an edge field of view of a projection picture. There is no need for focusing a mechanical structure, no noise is generated in the focusing process, costs of a motor and a steering structure in an automatic adjustment process are saved, and a preparation cost of the projection device is reduced. For some projectors using a large-size single LCD, such as a single LCD projector with 5 inches (a size of the display assembly 14, not a size of a projection picture) and a resolution of 2K or 4K, in a design process of an imaging lens, a problem of blocking an optical path due to a very short working distance between the lens assembly 17 and the display assembly 14 will not occur.

In an embodiment of the present disclosure, in a structure in which a plurality of liquid crystal sub-lenses are adopted for the lens assembly 17, static focusing may be performed by adjusting voltages of first electrodes in the liquid crystal sub-lenses, and mechanical focusing is not required, so that the above-mentioned problem of image quality degradation caused by adjusting an imaging lens (that is, the lens assembly 17) may be avoided, and a cost may be reduced and blocking an optical path may be avoided. In an embodiment of the present disclosure, a structure of a plurality of liquid crystal sub-lenses is adopted for the lens assembly 17, and a focal length of a projection device may be adjusted by adjusting voltages of first electrodes in the plurality of liquid crystal sub-lenses and a voltage of a first electrode in the liquid crystal lens 15, or only voltages of first electrodes in the plurality of liquid crystal sub-lenses in the lens assembly 17 may be adjusted for focusing, or only the first electrode in the liquid crystal lens 15 may be adjusted for focusing. In addition, in an embodiment of the present disclosure, a structure of a liquid crystal lens is adopted for each of the lens assembly 17 and the liquid crystal lens 15, and compared with a case that a plurality of lenses are adopted for the lens assembly 17 and a second Fresnel lens is adopted at a position of the liquid crystal lens 15, the structure of the liquid crystal lens according to the embodiment of the present disclosure may reduce a volume of the projection device. Since a focal length of the liquid crystal lens is adjusted by controlling a voltage applied to a first electrode 1531, how much focal length is needed only requires adjusting deflection angles of liquid crystal molecules, there is no need to increase a physical structure, or increase a volume of the lens, so space of the projection device may be saved and the volume of the projection device may be reduced.

An embodiment of the present disclosure also provides a projector including the projection device according to any of the above embodiments.

An embodiment of the present disclosure also provides a display system, which, as shown in FIG. 12, may include: the projection device or projector according to any one of the above embodiments; and a projection curtain configured to project light emitted from the projection device or the projector to form a projection picture.

In an embodiment of the present disclosure, the projection curtain may be a projection plane or a projection screen, or may be another structure capable of presenting a projection picture.

An embodiment of the present disclosure also provides a projection picture adjustment device, which is applied to the projection device or the projector described in any of the above embodiments. As shown in FIG. 13, the projection picture adjustment device may include a projection distance sensor and a processor, the projection device or the projector may include a liquid crystal lens, the liquid crystal lens may include a first conductive layer and a second conductive layer disposed oppositely, a liquid crystal layer is disposed between the first conductive layer and the second conductive layer, the first conductive layer may include a plurality of first electrodes, and the second conductive layer may include a second electrode.

The projection distance sensor is configured to sense a projection distance, to generate projection distance information according to the sensed projection distance, and to transmit the projection distance information to the processor.

The processor is configured to control voltages applied to the second electrode and the plurality of first electrodes according to the projection distance information.

In an exemplary implementation mode, the projection distance sensor may be a distance sensor and the processor may be a Microcontroller Unit (MCU) or a Central Processing Unit (CPU).

In an exemplary implementation mode, a plurality of groups of data may be pre-stored in the processor, and each group of data includes projection distance information, voltage information of the second electrode and voltage information of the plurality of first electrodes corresponding to the projection distance information in the group of data. After receiving the projection distance information from the projection distance sensor, the processor finds out pre-stored projection distance information corresponding to the received projection distance information among the pre-stored plurality of groups of data, obtains corresponding voltage information of the second electrode and voltage information of the plurality of first electrodes according to the found pre-stored projection distance information, controls a voltage applied to the second electrode in the liquid crystal lens according to the obtained voltage information of the second electrode, and controls a voltage applied to the plurality of first electrodes in the liquid crystal lens according to the obtained voltage information of the plurality of first electrodes.

In an exemplary implementation mode, each group of data may include pre-stored projection distance information and corresponding voltage information of a second electrode and voltage information of a plurality of first electrodes, which may be acquired in a design process of a backward optical path. For example, in pre-stored multiple groups of data, each group of data corresponds to a size of one projection picture and each projection picture size corresponds to one projection distance. Under this projection distance, in a design process of a backward optical path, by adjusting voltages of the second electrode and the first electrodes at different positions in the liquid crystal lens 15, a better image quality may be obtained. For example, a diameter of a spot where light emitted by a light source of a projection curtain is converged on the display assembly 14 is less than a pixel size of the display assembly 14, and it may be considered that image quality is better. Corresponding voltages of the second electrode and the plurality of first electrodes are pre-stored, so as to obtain pre-stored projection distance information and corresponding voltage information of the second electrode and the plurality of first electrodes in this group of data.

An embodiment of the present disclosure also provides a projection picture adjustment method, which is applied to the projection device or projector according to any one of the above embodiments. The projection device or projector includes a liquid crystal lens, the liquid crystal lens includes a first conductive layer and a second conductive layer disposed oppositely, a liquid crystal layer is disposed between the first conductive layer and the second conductive layer, the first conductive layer includes a plurality of first electrodes, and the second conductive layer includes a second electrode. As shown in FIG. 14, the projection picture adjustment method may include following acts.

Act H1: a projection distance is sensed, and projection distance information is generated according to the sensed projection distance.

Act H2: voltages applied to the second electrode and the plurality of first electrodes are controlled according to the projection distance information.

In an exemplary implementation mode, the act H2 may include: pre-stored corresponding projection distance information is searched according to the projection distance information, corresponding voltage information applied to the second electrode and voltage information of the plurality of first electrodes is acquired according to the searched projection distance information, a voltage applied to the second electrode is controlled according to the acquired voltage information of the second electrode, and a voltage applied to the plurality of first electrodes is controlled according to the acquired voltage information of the plurality of first electrodes.

In an exemplary implementation mode, multiple groups of data may be pre-stored, each group of data may include pre-stored projection distance information and corresponding voltage information of the second electrode and voltage information of the plurality of first electrodes, which may be acquired in a design process of a backward optical path. For example, in pre-stored multiple groups of data, each group of data corresponds to a size of one projection picture and each projection picture size corresponds to one projection distance. Under this projection distance, in a design process of a backward optical path, by adjusting voltages of the second electrode and the first electrodes at different positions in the liquid crystal lens 15, better image quality may be obtained. For example, a diameter of a spot where light emitted by a light source of a projection curtain is converged on the display assembly 14 is less than a pixel size of the display assembly 14, and it may be considered that image quality is better. Corresponding voltages of the second electrode and the plurality of first electrodes are pre-stored, so as to obtain pre-stored projection distance information and corresponding voltage information of the second electrode and the plurality of first electrodes in this group of data.

An embodiment of the present disclosure also provides a projection method, which is applied to the projection device or projector according to any one of the above embodiments. The projection device or projector includes a liquid crystal lens, the liquid crystal lens includes a first conductive layer and a second conductive layer disposed oppositely, a liquid crystal layer is disposed between the first conductive layer and the second conductive layer, the first conductive layer includes a plurality of first electrodes, and the second conductive layer includes a second electrode. The projection method may include: corresponding voltages are applied to the second electrode and the plurality of first electrodes.

In an exemplary implementation mode, the voltages applied to the second electrode and the plurality of first electrodes may be preset, for example, under a condition that a projection distance and a projection picture remain unchanged, a preset voltage may be applied to the second electrode and the plurality of first electrodes in the liquid crystal lens for each projection to form a projection picture.

In an exemplary implementation mode, the preset voltages of the second electrode and the plurality of first electrodes may be acquired through a backward optical path design, and an acquisition method may be referred to the above contents, and will not be described in detail here.

In an exemplary implementation mode, before applying the corresponding voltages to the second electrode and the plurality of first electrodes, the projection method may further includes: a projection distance is sensed, and projection distance information is generated according to the sensed projection distance. Accordingly, applying the corresponding voltages to the second electrode and the plurality of first electrodes may include: controlling the voltages applied to the second electrode and the plurality of first electrodes according to the projection distance information. In an exemplary implementation mode, an implementation mode in which the voltages applied to the second electrode and the plurality of first electrodes are controlled according to the projection distance information may be referred to above-described contents, and will not be described in detail here.

In the projection device and method, the projector, the display system, the picture adjustment device and method according to embodiments of the present disclosure, a focal length of a projection device is adjusted through voltages applied to liquid crystal molecules in a liquid crystal lens, and a problem of degradation of picture quality of a projection after zooming may be avoided.

Following points need to be noted.

The drawings of the embodiments of the present disclosure only involve structures involved in the embodiments of the present disclosure, and other structures may be referred to general designs.

The embodiments of the present disclosure, i.e., features in the embodiments, may be combined with each other to obtain new embodiments if there is no conflict.

Although implementation modes of the present disclosure are disclosed above, contents described are only implementation modes used for ease of understanding of the present disclosure, but not intended to limit the present disclosure. Any of those skilled in the art of the present disclosure may make any modification and variation in form and details of implementation without departing from the spirit and scope of the present disclosure. However, the patent protection scope of the present disclosure should be subject to the scope defined in the appended claims.

1. A projection device, comprising:
a light source assembly;
a display assembly disposed on a side of the light source assembly that emits light, wherein light emitted from the light source assembly is projected to a non-display side of the display assembly; and
a liquid crystal lens disposed on a side of the display assembly away from the light source assembly, and a focal length of the projection device is adjusted through voltages applied to liquid crystal molecules in the liquid crystal lens.

2. The projection device according to claim 1, further comprising a lens assembly disposed on a display side of the display assembly, wherein a light incident side of the lens assembly is disposed close to the display side.

3. The projection device according to claim 2, wherein the lens assembly comprises a plurality of liquid crystal sub-lenses, the liquid crystal lens and each of the liquid crystal sub-lenses each comprises a first substrate and a second substrate disposed oppositely, and a liquid crystal layer disposed between the first substrate and the second substrate; a side of the first substrate close to the second substrate is provided with a first conductive layer, a side of the second substrate close to the first substrate is provided with a second conductive layer, the first conductive layer comprises a plurality of first electrodes, and the second conductive layer comprises a second electrode.

4. The projection device according to claim 3, wherein a first electrode has a ring-shaped structure, and the plurality of first electrodes are arranged at intervals along a direction from a center to an edge of the first substrate.

5. The projection device according to claim 3, wherein in the liquid crystal lens, the first substrate is located on a side of the liquid crystal lens close to the light source assembly, and the second substrate is located on a side of the liquid crystal lens away from the light source assembly.

6. The projection device according to claim 3, wherein the plurality of liquid crystal sub-lenses in the lens assembly comprise a first liquid crystal sub-lens, a second liquid crystal sub-lens, a third liquid crystal sub-lens, and a fourth liquid crystal sub-lens, and the first liquid crystal sub-lens to the fourth liquid crystal sub-lens are sequentially arranged along a direction from the light incident side to a light exit side.

7. The projection device according to claim 6, wherein in the first liquid crystal sub-lens and the fourth liquid crystal sub-lens, a first substrate is located on a side close to the second liquid crystal sub-lens, and a second substrate is located on a side away from the second liquid crystal sub-lens;
in the second liquid crystal sub-lens, a first substrate is located on a side close to the first liquid crystal sub-lens, and a second substrate is located on a side close to the third liquid crystal sub-lens; and
in the third liquid crystal sub-lens, a first substrate is located on a side close to the fourth liquid crystal sub-lens, and a second substrate is located on a side close to the second liquid crystal sub-lens.

8. The projection device according to claim 3, wherein a refractive index of a liquid crystal molecule in the liquid crystal layer is:
$$n ( θ ) = \frac{{n}_{o} {n}_{e}}{\sqrt{{n}_{o}^{2} {sin}^{2} θ + {n}_{e}^{2} {cos}^{2} θ}} ;$$
wherein n(θ) is the refractive index of the liquid crystal molecule, θ is a deflection angle of the liquid crystal molecule, nₒ is a first refractive index, nₑ is a second refractive index, one of the first refractive index nₒ and the second refractive index nₑ is a maximum refractive index of the liquid crystal molecule, the other is a minimum refractive index of the liquid crystal molecule, and a value range of the refractive index n(θ) of the liquid crystal molecule is between the first refractive index nₒ and the second refractive index nₑ.

9. The projection device according to claim 2, further comprising a reflecting mirror;
wherein the reflecting mirror is disposed on the light incident side of the lens assembly, light emitted from the display assembly is projected to a reflecting surface of the reflecting mirror via the liquid crystal lens, and light reflected by the reflecting surface is projected to the light incident side of the lens assembly.

10. The projection device according to claim 1, wherein each light emitting point corresponding to light projected to the display assembly in the light source assembly serves as a Lambert body.

11. The projection device according to claim 10, further comprising a focusing lens and a heat insulation structure, wherein the light source assembly comprises a light source and a light reflecting structure; and
the light reflecting structure is disposed on a side of the light source that emits light, the focusing lens is disposed on a side of the light reflecting structure far from the light source, the heat insulation structure is disposed between the focusing lens and the display assembly, and the heat insulation structure is disposed close to the focusing lens.

12. The projection device according to claim 11, wherein the focusing lens is a Fresnel lens, the display assembly is a liquid crystal display screen, the light source is a Light Emitting Diode (LED), and the heat insulation structure is heat insulation glass.

13. A projector, comprising a projection device according to claim 1.

14. A display system, comprising:
a projection device according to claim 1; and
a projection curtain configured to project light emitted from the projection device to form a projection picture.

15. A projection picture adjustment device applied to a projection device according to claim 1, comprising a projection distance sensor and a processor, wherein the projection device comprises a liquid crystal lens, the liquid crystal lens comprises a first conductive layer and a second conductive layer disposed oppositely, a liquid crystal layer is disposed between the first conductive layer and the second conductive layer, the first conductive layer comprises a plurality of first electrodes, and the second conductive layer comprises a second electrode;
the projection distance sensor is configured to sense a projection distance, to generate projection distance information according to the sensed projection distance, and to transmit the projection distance information to the processor; and
the processor is configured to control voltages applied to the second electrode and the plurality of first electrodes according to the projection distance information.

16. A projection picture adjustment method applied to a projection device according to claim 1, wherein the projection device comprises a liquid crystal lens, the liquid crystal lens comprises a first conductive layer and a second conductive layer disposed oppositely, a liquid crystal layer is disposed between the first conductive layer and the second conductive layer, the first conductive layer comprises a plurality of first electrodes, and the second conductive layer comprises a second electrode; and the method comprises:
sensing a projection distance and generating projection distance information according to the sensed projection distance; and
controlling voltages applied to the second electrode and the plurality of first electrodes according to the projection distance information.

17. A projection method applied to a projection device according to claim 1, wherein the projection device comprises a liquid crystal lens, the liquid crystal lens comprises a first conductive layer and a second conductive layer disposed oppositely, a liquid crystal layer is disposed between the first conductive layer and the second conductive layer, the first conductive layer comprises a plurality of first electrodes, and the second conductive layer comprises a second electrode; and the projection method comprises:
applying corresponding voltages to the second electrode and the plurality of first electrodes.

18. A display system, comprising:
a projector according to claim 13; and
a projection curtain configured to project light emitted from the projector to form a projection picture.

19. A projection picture adjustment device applied to a projector according to claim 13, comprising a projection distance sensor and a processor, wherein the projector comprises a liquid crystal lens, the liquid crystal lens comprises a first conductive layer and a second conductive layer disposed oppositely, a liquid crystal layer is disposed between the first conductive layer and the second conductive layer, the first conductive layer comprises a plurality of first electrodes, and the second conductive layer comprises a second electrode;
the projection distance sensor is configured to sense a projection distance, to generate projection distance information according to the sensed projection distance, and to transmit the projection distance information to the processor; and
the processor is configured to control voltages applied to the second electrode and the plurality of first electrodes according to the projection distance information.

20. A projection picture adjustment method applied to a projector according to claim 13, wherein the projector comprises a liquid crystal lens, the liquid crystal lens comprises a first conductive layer and a second conductive layer disposed oppositely, a liquid crystal layer is disposed between the first conductive layer and the second conductive layer, the first conductive layer comprises a plurality of first electrodes, and the second conductive layer comprises a second electrode; and the method comprises:
sensing a projection distance and generating projection distance information according to the sensed projection distance; and
controlling voltages applied to the second electrode and the plurality of first electrodes according to the projection distance information.
